(19) United States
(12) Patent Application Publication
(10) Pub. No.: US 2024/0083825 A1
(43) Pub. Date: Mar. 14, 2024

(54) CONTROLLED-RELEASE FERTILIZER AND PREPARATION METHOD THEREFOR TECHNICAL FIELD

(71) Applicant: Institute of Agricultural Resources and Environment, Sichuan Academy of Agricultural Sciences, Chengdu, Sichuan Province (CN)

(72) Inventors: Zijun Zhou, Chengdu, Sichuan Province (CN); Yusheng Qin, Chengdu, Sichuan Province (CN); Song Guo, Chengdu, Sichuan Province (CN); Kun Chen, Chengdu, Sichuan Province (CN); Xiangzhong Zeng, Chengdu, Sichuan Province (CN); Hua Yu, Chengdu, Sichuan Province (CN); Mingjiang He, Chengdu, Sichuan Province (CN); Yuxian Shangguan, Chengdu, Sichuan Province (CN); Yurou Dai, Chengdu, Sichuan Province (CN); Wanzhen Yuan, Chengdu, Sichuan Province (CN)

(21) Appl. No.: 18/249,814

(22) PCT Filed: Mar. 3, 2023
(86) PCT No.: PCT/CN2023/079446

§ 371 Date: Apr. 20, 2023

(30) Foreign Application Priority Data
Apr. 25, 2022 (CN) 202210440218.3

(51) Int. Cl. C05G 3/40; C05B 19/00; C05G 5/30

(52) U.S. Cl. CPC C05G 3/40; C05B 19/00; C05G 5/37

(57) ABSTRACT

A controlled-release fertilizer including an inside core of water-soluble fertilizer particle and an outer layer coating material, wherein the coating material is a bentonite modified or sodium bentonite modified waterborne polymer; and a preparation method including: weighing the fertilizer core particle and the modified waterborne polymer emulsion according to the amount, preparing a semi-processed coating controlled-release fertilizer by using a coating machine, and placing the semi-processed coating controlled-release fertilizer in an oven for postprocessing to improve the compactness of the film material.

### TECHNICAL FIELD

The present invention belongs to the field of chemical fertilizers, and relates to a controlled-release chemical fertilizer and a preparation method therefor.

### BACKGROUND

The chemical fertilizers provide essential nutrients for crop, and make an important contribution to guaranteeing the global food safety. According to the statistics, ½ of the crop yield per unit area and ⅓ of the total crop yield came from the contribution of chemical fertilizers in the 20th century. China accounting for 10% of the world's arable land consumed ⅓ of the world's fertilizers production, and the amount of the fertilization per hectare in China was 3 times of the average value in the world. The chemical fertilizers, especially nitrogen fertilizers, have a low utilization rate, which brings environmental, economic and energy pressure. The slow/controlled-release fertilizer has attracted worldwide attention due to the advantages of effectively improving the nutrient utilization rate, reducing the harm of nutrient loss to the environment, reducing the fertilization cost and the like, wherein the polymer coated fertilizer becomes one of the most promising controlled-release fertilizers at present due to a better controlled-release effect.

The polymer coated fertilizer is a controlled-release fertilizer which utilizes high molecular organic polymer to coat the surface of the traditional soluble fertilizer particles to form a film with a certain thickness and achieves the purpose of slowing down or controlling the release of nutrients by the osmosis of the film. However, most of the current commercial polymer coated fertilizers require the use of organic solvents in the synthetic process, which easily causes secondary pollution and safety problems.

In recent years, the rapid development of waterborne polyacrylate coated controlled-release fertilizers has become a major research focus of current polymer coated controlled-release fertilizers. The waterborne polyacrylate does not need an organic solvent in the synthesis and fertilizer production processes, and the finished product has the advantages such as no odor, easy degradation, relatively low price, easy synthesis, good film-forming property, suitable viscosity, and no fire accident in manufacturing, storage and transportation, so that it is considered as an ideal environment-friendly coated controlled-release material.

In the process of completing the present invention, the inventors found that the waterborne polyacrylate material had at least one of the following technical problems:

the waterborne polyacrylate coating material has insufficient strength and poor water resistance, so that the coated fertilizer prepared by using the waterborne polyacrylate coating material as the coating material has a quick nutrient release rate, the coating material has a low strength, and the coating is easy to break due to disturbance in the later release period, thus failing to meet the nutrient requirement of crops with a longer growing season in the whole growing season.

In the process of completing the present invention, in order to slow down the nutrient release rate of the waterborne polyacrylate coated fertilizer and improve the mechanical strength of the coating material, the inventors tried various physical/chemical modifications on the coating material. The bentonite modification, nano calcium carbonate modification and the like are used.

Bentonite is a clay whose main mineral is montmorillonite. China is at the forefront of the world in the bentonite ore reserves, and bentonite ore is distributed in more than 80 counties and cities of 26 provinces in China, however, most bentonite is a primary product, and the bentonite resource has a low utilization level. It is a currently urgent task to develop serialized new products with high-tech content and to expand the application field. Due to the structure of the bentonite, the bentonite has a series of characteristics such as good suspension property, ion exchange property, expansibility, binding property and adsorbability, without toxic or corrosive effect on humans, livestock and plants, and it is environment-friendly.

At present, for the applications of bentonite to fertilizers, the bentonite is mostly used as fertilizer binding auxiliary agents or fillers (Chinese Patent Application Nos.: 201710802324.0, 201611254814.3, 201510934887.6, 201610080592.1 and 201410762492.8), carrier materials of the matrix-based fertilizers (Chinese Patent Application Nos. 201210392722.7, 201610455152.X, 201610552283.X and 201611254814.3), and a slow-release fertilizer which is directly coated on the surface of the fertilizer alone or together with other substances (Chinese Patent Application Nos. 201710013120.9, 201711069175.8, 201510457551.5 and 201410762492.8).

The inventors have not found any patent or literature report in the prior art about applying bentonite as a modified functional material to waterborne polyacrylate coated controlled-release fertilizers.

### SUMMARY

In view of this, one of the purposes of the present invention is to provide a coated controlled-release fertilizer that has slow nutrient release and high film material strength, and is environment-friendly.

The other purpose of the present invention is to provide a preparation method for a coated controlled-release fertilizer that has slow nutrient release and high film material strength, and is environment-friendly.

The inventors have continuously reformed and innovated through long-term exploration and attempts, as well as multiple experiments and efforts, in order to solve the above technical problems, the technical scheme of the present invention is to provide a controlled-release fertilizer which comprises an inside core of fertilizer particle and an outer layer coating material, wherein the coating material is a bentonite modified or sodium bentonite modified waterborne polymer.

According to one embodiment of the controlled-release fertilizer of the present invention, the waterborne polymer is waterborne polyacrylate.

According to one embodiment of the controlled-release fertilizer of the present invention, the addition amount of the bentonite or sodium bentonite accounts for 0.01% to 6% of the amount of the dry matter of the waterborne polymer.

According to one embodiment of the controlled-release fertilizer of the present invention, the mass of the dry matter of the coating material accounts for 2.5% to 15% of the controlled-release fertilizer.

According to one embodiment of the controlled-release fertilizer of the present invention, the inside core of fertilizer particle comprises a straight fertilizer particle contained nitrogen nutrient, phosphate nutrient or/and potash nutrient or a composite fertilizer particle.

The present invention further provides a preparation method for the controlled-release fertilizer, which comprises a coating step:

weighing the inside core of fertilizer particle and the modified waterborne polymer emulsion according to the amount, preparing a semi-processed coating controlled-release fertilizer by using a coating machine, and placing the semi-processed coating controlled-release fertilizer in an oven for postprocessing to improve the compactness of the film material. The controlled-release base fertilizer is an intermediate state in the preparation process of the controlled-release fertilizer.

According to one embodiment of the preparation method for the controlled-release fertilizer of the present invention, the coating step is:

weighing the inside core of fertilizer particle and the modified polyacrylate emulsion according to the amount, preparing a semi-processed coating controlled-release fertilizer by using a coating machine, and placing the semi-processed coating controlled-release fertilizer in a 60° C. oven for postprocessing for 8 h to improve the compactness of the film material.

According to one embodiment of the preparation method for the controlled-release fertilizer of the present invention, the modified waterborne polymer emulsion is prepared by the following steps:

weighing waterborne polymer emulsion with dry matter accounting for 2.5% to 15% of the weight of the controlled-release fertilizer according to the requirement of the actual nutrient slow-release longevity based on the waterborne polymer emulsion with known solid content;

adding bentonite or sodium bentonite into a preset amount of deionized water, and fully mixing the mixture to obtain a bentonite or sodium bentonite solution; and

then slowly adding the bentonite or sodium bentonite solution into the waterborne polymer emulsion, and fully stirring the mixture to prepare the bentonite or sodium bentonite modified waterborne polymer emulsion.

According to one embodiment of the preparation method for the controlled-release fertilizer of the present invention, the waterborne polymer is waterborne polyacrylate, and the modified waterborne polyacrylate emulsion is prepared by the following steps:

weighing waterborne polyacrylate emulsion with dry matter accounting for 2.5% to 15% of the weight of the controlled-release fertilizer according to the requirement of the actual nutrient slow-release longevity based on the waterborne polyacrylate emulsion with known solid content;

adding bentonite or sodium bentonite into deionized water with the same amount as the waterborne polyacrylate emulsion, and performing ultrasonic treatment for 20 minutes to obtain a bentonite or sodium bentonite solution; and

then slowly adding the bentonite or sodium bentonite solution into the waterborne polyacrylate emulsion, and stirring the mixture for 15 minutes by using a magnetic stirrer to prepare the sodium bentonite modified waterborne polyacrylate emulsion.

According to one embodiment of the preparation method for the controlled-release fertilizer of the present invention, the sodium bentonite is prepared by the following steps:

adding 0.4 part by weight of sodium carbonate into 10 parts by weight of bentonite sieved by a 200-mesh sieve, adding 100 parts by weight of deionized water thereto, electrically stirring the mixture in a water bath at 60° C. for 1.5 h, filtering the mixture twice after the completion of the reaction, drying the filtered mixture at 100° C., crushing the dried mixture, and sieving the crushed mixture by a 200-mesh sieve for later use.

Compared with the prior art, one of the technical schemes described above has the following advantages:
a) The present invention adopts bentonite or sodium bentonite to modify the waterborne polymer, and the bentonite has a series of characteristics such as good suspension property, ion exchange property, expansibility, thixotropy, binding property and adsorbability, has no toxic or corrosive effect on humans, livestock and plants, and it is environment-friendly.
b) The modified waterborne polymer coating material obtained by the present invention has significantly improved mechanical properties such as tensile strength, and the prepared coated controlled-release fertilizer has a significant controlled-release effect.
c) The controlled-release fertilizer has a simple production process, low cost and wide application prospect. The cost of the waterborne polyacrylate is higher than that of bentonite and sodium bentonite, and the waterborne polyacrylate suitable for the method of the present invention is lower in use amounts under the condition of reaching the same slow-release effect standard, so that the production cost of the controlled-release fertilizer is further reduced.
d) Tests have proven that the bentonite modified waterborne polyacrylate as a coating material has a better controlled-release effect than unmodified waterborne polyacrylate, and the difference therebetween is significant; the sodium bentonite modified waterborne polyacrylate as a coating material has a better controlled-release effect than the bentonite modified waterborne polyacrylate, and the difference therebetween is significant; the addition amount of the sodium bentonite needs to be proper, and the controlled-release effect is not always better when more sodium bentonite is added.
e) Comparative tests have proven that, under the condition that the use amounts of coating materials and inside core of fertilizer particle are the same and the preparation process is the same, compared with unmodified waterborne polyacrylate, the sodium bentonite modified waterborne polyacrylate has the advantages that: the controlled-release fertilizer with the improved coating material has a lower accumulative release rate compared with the fertilizer at the same period and a more smooth and uniform release speed, and the release period may be prolonged by about 1.7 times, which can meet the nutrient requirement of crops with a longer growing season in the whole growing season.

### DETAILED DESCRIPTION OF THE EMBODIMENTS

The present invention will be illustrated with reference to the following specific examples. Example 1 is a comparative example in which the unmodified waterborne polyacrylate was used as a coating material, in Example 2, the bentonite modified waterborne polyacrylate was used as a coating material, and in Examples 3 and 4, the sodium bentonite modified waterborne polyacrylate was used as a coating material. Examples 1 to 4 all comprise the controlled-release fertilizer and the preparation method therefor.

In order to make the objects, technical schemes and advantages of the embodiments of the present invention more apparent, the technical schemes in the embodiments of the present invention will be clearly and completely described below with reference to the embodiments of the present invention, and it is obvious that the described embodiments are only a part of the embodiments of the present invention but not all of them. Based on the embodiments of the present invention, all other embodiments obtained by those of ordinary skill in the art without creative effort shall fall within the protection scope of the present invention. Therefore, the following detailed description of the embodiments of the present invention is not intended to limit the scope of the present invention as claimed, but is merely representative of selected embodiments of the present invention.

In Examples 1 to 4, the method for determining the accumulative release rate of nutrients was as follows: randomly selecting the coated fertilizers with complete granules from the sealed and stored coated fertilizers, repeating each treatment 3 times and performing each treatment on 5 g of the coated fertilizers, accurately weighing the coated fertilizers in each repeated treatment (rounding to two decimal places) and then placing the weighed coated fertilizers into a wide-mouth bottle (sealed by a rubber stopper) containing 100 mL of deionized water, placing the wide-mouth bottle into an incubator at 25° C., and performing sampling at regular intervals. After each sampling, all leachate in the wide-mouth bottle was poured out, and 100 mL of deionized water was added again to continue the culture in the incubator at 25° C. The urea was determined on a flow analyzer by using a colorimetry method of para-dimethyl-amino-benzaldehyde so as to obtain the accumulative release rate of the nutrients.

In Examples 1 to 4, the method for determining the mechanical property data of the coating material was as follows: cutting the prepared model film into a dumbbell-shaped coating by using a cutter according to the National Standard GB/T528-2009. The size of the cutter was (50×4 mm), the mechanical property of the coating material was determined by using an Instron 3366 model universal testing machine, the sample was automatically injected with the tensile speed of 10 mm/min, the camera was used for tracking, and the test was performed at the temperature of 23° C. and under the humidity of 50%. The tensile strength of the coating material was determined. The preparation method for the waterborne polyacrylate emulsion model film was as follows: placing the smooth and flat polytetrafluoroethylene plate in a blast drying oven, leveling the polytetrafluoroethylene plate by using a leveling instrument and an aluminum sheet, and slowly pouring the uniformly stirred coating solution onto the polytetrafluoroethylene plate to freely extend and form a film. The film was placed in a drying oven at 40° C. for 10 h, the temperature was adjusted to 80° C., and the film was continuously baked for 24 h to obtain the model film.

In Examples 1 to 4, the coating process of the controlled-release fertilizer, i.e., the conditions in step c, was the same.

In Examples 3 and 4, the sodium bentonite was prepared by the following steps: adding 0.4 part by weight of sodium carbonate into 10 parts by weight of bentonite sieved by a 200-mesh sieve, adding 100 parts by weight of deionized water thereto, electrically stirring the mixture in a water bath at 60° C. for 1.5 h, filtering the mixture twice after the completion of the reaction, drying the filtered mixture at 100° C., crushing the dried mixture, and sieving the crushed mixture by a 200-mesh sieve for later use.

In Examples 2 to 4, the modified waterborne polyacrylate emulsion was prepared by the following steps:

weighing waterborne polyacrylate emulsion with dry matter accounting for 2.5% to 15% of the weight of the controlled-release fertilizer according to the requirement of the actual nutrient slow-release longevity based on the waterborne polyacrylate emulsion with known solid content;

adding bentonite or sodium bentonite into deionized water with the same amount as the waterborne polyacrylate emulsion, and performing ultrasonic treatment for 20 minutes to obtain a bentonite or sodium bentonite solution; and

then slowly adding the bentonite or sodium bentonite solution into the waterborne polyacrylate emulsion, and stirring the mixture for 15 minutes by using a magnetic stirrer to prepare the bentonite or sodium bentonite modified waterborne polyacrylate emulsion.

### Example 1

This example described a preparation method for a controlled-release fertilizer based on an unmodified waterborne polyacrylate coating, and the controlled-release fertilizer obtained by this preparation method. The specific steps of the preparation method for the controlled-release fertilizer in this example were as follows:

Step a, selecting a coating mother liquor:

preparing 100 g of waterborne polyacrylate emulsion with the solid content of (49±1)% in a laboratory by using a waterborne process.

Step b, preparing a coating solution:

slowly adding dropwise distilled water with the same amount as the coating mother liquor into the stirred coating mother liquor, and continuously stirring for 15 minutes after all the distilled water was added dropwise; wherein the coating solution prepared by uniformly mixing should be used immediately, and the storage temperature was 5-25° C., and the storage time was not longer than 4 h.

Step c, coating:

putting 500 g of urea into a coating cavity by using a bottom jet fluidized bed coating machine, such as LDP-3 fluidized bed coating equipment produced by Changzhou Jiafa Granulating Drying Equipment Co., Ltd. in Jiangsu, after the fertilizer was well fluidized, pumping the coating solution into the coating cavity by a peristaltic pump in which the coating solution atomized and attached to the surfaces of fertilizer particles, then gradually forming a layer of uniform film on the surfaces of the fertilizer particles through up-and-down circulating motion in the coating cavity, and finally obtaining the coated fertilizer. In the process of coating by the fluidized bed, coating parameters such as pumping speed, air inlet temperature, air outlet temperature and atomization pressure of the coating solution were properly adjusted according to the property of the coating solution, so that the water volatilization speed in the coating process was consistent with the film forming reaction, and coating failure caused by film forming influence was avoided. It required about 1.5 to 2 h to complete one coating process for every 0.5 kg of fertilizer using this equipment.

The accumulative release rate of nutrients of the controlled-release fertilizer prepared by this example is shown in Table 1, and the mechanical property effect of the model film is shown in Table 2. The tensile strength of the model film in this example was 13.21 MPa; after the controlled-release fertilizer was released in distilled water at 25° C. for 1 day, the accumulative release rate was about 23.51%, and the accumulative release rate of nutrients reached 62.18% at day 28.

The controlled-release fertilizer of this example was acceptable in its controlled-release effect, however, the controlled-release effect was necessary and possible to modify.

According to Table 1, the accumulative release rate of the fertilizer from day 1 to day 10 in this example satisfies the following equation:

y=2.4266x+20.856(R²=0.9982).

The accumulative release rate of the fertilizer after day 10 in this example satisfies the following equation:

y=0.9225x+36.063(R²=0.9971).

In the above equation, y is the accumulative release rate and x is the days of release.

According to the prediction of a mathematical model, the estimated period of the complete release of the controlled-release fertilizer in this example is 69 days.

### Example 2

This example described a preparation method for a controlled-release fertilizer based on a bentonite modified waterborne polyacrylate coating, and the controlled-release fertilizer obtained by this preparation method. The specific steps of the preparation method for the controlled-release fertilizer in this example were as follows:

Step a, selecting a coating mother liquor:

preparing 100 g of waterborne polyacrylate emulsion with the solid content of (49±1)% in a laboratory by using a waterborne process.

Step b, preparing a coating solution:

adding 100 g of deionized water into 0.75 g of the sieved bentonite, slowly adding dropwise the mixture into the stirred coating mother liquor, and continuously stirring for 15 minutes after all the mixture was added dropwise; wherein the coating solution prepared by uniformly mixing should be used immediately, and the storage temperature was 5-25° C., and the storage time was not longer than 4 h.

Step c, coating:

the specific step was the same as that in Example 1.

The accumulative release rate of nutrients of the controlled-release fertilizer prepared by this example is shown in Table 1, and the mechanical property effect of the model film is shown in Table 2. The tensile strength of the model film in this example was 14.10 MPa; after the controlled-release fertilizer was released in distilled water at 25° C. for 1 day, the accumulative release rate was about 18.23%, and the accumulative release rate of nutrients reached 52.32% at day 28. It is noted that, with the addition of bentonite, the tensile strength of the waterborne polymer material is increased, the nutrient release rate is reduced, and the controlled-release period of the fertilizer nutrients is prolonged.

According to Table 1, the accumulative release rate of the fertilizer from day 1 to day 10 in this example satisfies the following equation:

y=1.7758x+16.676(R²=0.9993).

The accumulative release rate of the fertilizer after day 10 in this example satisfies the following equation:

y=0.9942x+24.203(R²=0.9983).

In the above equation, y is the accumulative release rate and x is the days of release.

According to the prediction of a mathematical model, the estimated period of the complete release of the controlled-release fertilizer in this example is 76 days, which is 7 days longer than the estimated period (69 days) in Example 1. The release speed of the fertilizer from day 1 to day 10 in this example is significantly slower than that of the fertilizer in Example 1, and the release speed of the fertilizer after day 10 is slightly faster than that of the fertilizer in Example 1, and the overall performance shows that the release speed of the fertilizer is more uniform due to the bentonite modified waterborne polyacrylate coating.

### Example 3

This example described a preparation method for a controlled-release fertilizer based on a sodium bentonite modified waterborne polyacrylate coating, and the controlled-release fertilizer obtained by this preparation method. The specific steps of the preparation method for the controlled-release fertilizer in this example were as follows:

Step a, selecting a coating mother liquor:

preparing 100 g of waterborne polyacrylate emulsion with the solid content of (49±1)% in a laboratory by using a waterborne process.

Step b, preparing a coating solution:

adding 100 g of deionized water into 0.75 g of sieved sodium bentonite, performing ultrasonic treatment on the mixture for 20 minutes, slowly adding dropwise the mixture into the stirred coating mother liquor after the ultrasonic treatment, and continuously stirring for 15 minutes after all the mixture was added dropwise; wherein the coating solution prepared by uniformly mixing should be used immediately, and the storage temperature was 5-25° C., and the storage time was not longer than 4 h.

Step c, coating:

the specific step was the same as that in Example 1.

The accumulative release rate of nutrients of the controlled-release fertilizer prepared by this example is shown in Table 1, and the mechanical property effect of the model film is shown in Table 2. The tensile strength of the model film in this example was 17.18 MPa; after the controlled-release fertilizer was released in distilled water at 25° C. for 1 day, the accumulative release rate was about 7.45%, and the accumulative release rate of nutrients reached 32.66% at day 28. It is noted that the effect of the sodium bentonite modified waterborne polyacrylate is better than that of the common bentonite, and the tensile strength and the nutrient controlled-release performance thereof are greatly improved compared with the common bentonite.

According to Table 1, the accumulative release rate of the fertilizer from day 1 to day 10 in this example satisfies the following equation:

y=1.3703x+6.2923(R²=0.9848).

The accumulative release rate of the fertilizer after day 10 in this example satisfies the following equation:

y=0.713x+12.622(R²=0.9917).

In the above equation, y is the accumulative release rate and x is the days of release.

According to the prediction of a mathematical model, the estimated period of the complete release of the controlled-release fertilizer in this example is 122 days. The estimated period of the complete release of the controlled-release fertilizer in this example is 53 days longer than the estimated period (69 days) in Example 1, and the nutrient requirement of crops with a longer growing season in the whole growing season can be met.

### Example 4

This example described a preparation method for a controlled-release fertilizer based on a sodium bentonite modified waterborne polyacrylate coating, and the controlled-release fertilizer obtained by this preparation method. The specific steps of the preparation method for the controlled-release fertilizer in this example were as follows:

Step a, selecting a coating mother liquor:

preparing 100 g of waterborne polyacrylate emulsion with the solid content of (49±1)% in a laboratory by using a waterborne process.

Step b, preparing a coating solution:

adding 100 g of deionized water into 1.5 g of sieved sodium bentonite, performing ultrasonic treatment on the mixture for 20 minutes, slowly adding dropwise the mixture into the stirred coating mother liquor after the ultrasonic treatment, and continuously stirring for 15 minutes after all the mixture was added dropwise; wherein the coating solution prepared by uniformly mixing should be used immediately, and the storage temperature was 5-25° C., and the storage time was not longer than 4 h.

Step c, coating:

the specific step was the same as that in Example 1.

The accumulative release rate of nutrients of the controlled-release fertilizer prepared by this example is shown in Table 1, and the mechanical property effect of the model film is shown in Table 2. The tensile strength of the model film in this example was 15.56 MPa; after the controlled-release fertilizer was released in distilled water at 25° C. for 1 day, the accumulative release rate was about 10.49%, and the accumulative release rate of nutrients reached 41.07% at day 28.

According to Table 1, the accumulative release rate of the fertilizer from day 1 to day 10 in this example satisfies the following equation:

y=1.6686x+9.333(R²=0.9891).

The accumulative release rate of the fertilizer after day 10 in this example satisfies the following equation:

y=0.8581x+17.51(R²=0.991).

In the above equation, y is the accumulative release rate and x is the days of release.

According to the prediction of a mathematical model, the estimated period of the complete release of the controlled-release fertilizer in this example is 96 days.

TABLE 1
Accumulative release rates of nutrients
of different controlled-release fertilizers

| | Sampling time (day) | | | | | | | |
|---|---|---|---|---|---|---|---|---|
| Examples | 1 | 3 | 5 | 7 | 10 | 14 | 21 | 28 |
| Example 1 | 23.51 | 27.76 | 33.34 | 37.45 | 45.31 | 49.23 | 54.87 | 62.18 |
| Example 2 | 18.23 | 22.21 | 25.65 | 29.13 | 34.33 | 38.11 | 44.63 | 52.32 |
| Example 3 | 7.45 | 10.1 | 13.42 | 16.77 | 19.35 | 23.31 | 27.22 | 32.66 |
| Example 4 | 10.49 | 14.23 | 18.56 | 21.33 | 25.44 | 30.08 | 36.09 | 41.07 |

TABLE 2
Mechanical properties of model films prepared
from polymer emulsions in different examples

| | Number of emulsion | | | |
|---|---|---|---|---|
| | Example 1 | Example 2 | Example 3 | Example 4 |
| Tensile | 13.21 ± 0.23 | 14.10 ± 0.36 | 17.18 ± 0.55 | 15.56 ± 0.27 |
| strength | (d) | (c) | (a) | (b) |
| (MPa) | | | | |

Note: the same lowercase letters indicate no significant difference in tensile strength at P<0.05.

Experimental data show that the modification effect of the waterborne polyacrylate is not always better when more sodium bentonite is added, and when the addition amount is too high, the bentonite agglomeration will occur, the dispersion effect of the bentonite in the waterborne polymer is reduced, and the modification effect of the bentonite is further reduced. Therefore, the use amount and the pretreatment mode of the bentonite for modification are key factors for the success of modification.

It can be seen from the mathematical model, the release speeds of the chemical fertilizers in the four controlled-release fertilizers show the characteristics of fast speed first and then slow speed, which results from that, on one hand, the fertilizers can be released at a high speed because the coating quality of part of fertilizer core particles is low such as incomplete coating, and on the other hand, the total nutrients of the fertilizers in the fertilizer particles are less and less at the later period, and the corresponding daily release speed is reduced. After the bentonite and the sodium bentonite are used for modification, the tensile strength of the model film is significantly improved, and the coating quality is also improved, which facilitates the reduction of the release speed of the chemical fertilizer of the controlled-release fertilizer at the initial period.

The above descriptions are only preferred embodiments of the present invention. It should be noted that the above-mentioned preferred embodiments should not be considered as limiting the present invention, and the protection scope of the present invention shall be subject to the protection scope of the claims. Those of ordinary skill in the art can also make several improvements and modifications without departing from the spirit and scope of the present invention, and such improvements and modifications shall also fall within the protection scope of the present invention.

What is claimed is:

1. A controlled-release fertilizer, comprising an inside core of water-soluble fertilizer particle and an outer layer coating material, wherein the coating material is bentonite modified or sodium bentonite modified waterborne polymer emulsion; the waterborne polymer is waterborne polyacrylate; and the modified waterborne polymer emulsion is prepared by the following steps:
weighing waterborne polymer emulsion with dry matter accounting for 2.5% to 15% of the weight of the controlled-release fertilizer according to the requirement of the actual nutrient slow-release period based on the waterborne polymer emulsion with known solid content;
adding bentonite or sodium bentonite into a preset amount of deionized water, and fully mixing the mixture to prepare a bentonite or sodium bentonite solution; and
then slowly adding the bentonite or sodium bentonite solution into the waterborne polymer emulsion, and fully stirring the mixture to prepare the bentonite or sodium bentonite modified waterborne polymer emulsion.

2. The controlled-release fertilizer according to claim 1, wherein the addition amount of the bentonite or sodium bentonite accounts for 0.01% to 6% of the amount of the dry matter of the waterborne polymer.

3. The controlled-release fertilizer according to claim 1, wherein the mass of the dry matter of the coating material accounts for 2.5% to 15% of the controlled-release fertilizer.

4. The controlled-release fertilizer according to claim 1, wherein the inside core of water-soluble fertilizer particle comprises a straight fertilizer particle contained nitrogen nutrient, phosphate nutrient or/and potash nutrient or a composite fertilizer particle.

5. A preparation method for the controlled-release fertilizer according to any one of claims 1 to 4, comprising a coating step:
weighing the inside core of fertilizer particle and the modified waterborne polymer emulsion according to the amount, preparing a semi-processed coating controlled-release fertilizer by using a coating machine, and placing the semi-processed coating controlled-release fertilizer in an oven for postprocessing to improve the compactness of the film material; wherein the waterborne polymer emulsion is waterborne polyacrylate emulsion.

6. The preparation method according to claim 5, wherein the coating step is:
weighing the inside core of fertilizer particle and the modified waterborne polyacrylate emulsion according to the amount, preparing a semi-processed coating controlled-release fertilizer by using a coating machine, and placing the semi-processed coating controlled-release fertilizer in a 60° C. oven for postprocessing for 8 h to improve the compactness of the film material.

7. The preparation method according to claim 5, wherein the modified waterborne polymer emulsion is prepared by the following steps:
weighing waterborne polymer emulsion with dry matter accounting for 2.5% to 15% of the weight of the controlled-release fertilizer according to the requirement of the actual nutrient slow-release period based on the waterborne polymer emulsion with known solid content;
adding bentonite or sodium bentonite into a preset amount of deionized water, and fully mixing the mixture to obtain a bentonite or sodium bentonite solution; and
then slowly adding the bentonite or sodium bentonite solution into the waterborne polymer emulsion, and fully stirring the mixture to prepare the bentonite or sodium bentonite modified waterborne polymer emulsion.

8. The preparation method according to claim 7, wherein the waterborne polymer is waterborne polyacrylate, and the modified waterborne polyacrylate emulsion is prepared by the following steps:
weighing waterborne polyacrylate emulsion with dry matter accounting for 2.5% to 15% of the weight of the controlled-release fertilizer according to the requirement of the actual nutrient slow-release period based on the waterborne polyacrylate emulsion with known solid content;
adding bentonite or sodium bentonite into deionized water with the same amount as the waterborne polyacrylate emulsion, and performing ultrasonic treatment for 20 minutes to obtain a bentonite or sodium bentonite solution; and
then slowly adding the bentonite or sodium bentonite solution into the waterborne polyacrylate emulsion, and stirring the mixture for 15 minutes by using a magnetic stirrer to prepare the bentonite or sodium bentonite modified waterborne polyacrylate emulsion.

9. The preparation method according to claim 7 or 8, wherein the sodium bentonite is prepared by the following steps:
adding 0.4 part by weight of sodium carbonate into 10 parts by weight of bentonite sieved by a 200-mesh sieve, adding 100 parts by weight of deionized water thereto, electrically stirring the mixture in a water bath at 60° C. for 1.5 h, filtering the mixture twice after the completion of the reaction, drying the filtered mixture at 100° C., crushing the dried mixture, and sieving the crushed mixture by a 200-mesh sieve for later use.
